(19) United States
(12) Patent Application Publication
(10) Pub. No.: US 2024/0013945 A1
(43) Pub. Date: Jan. 11, 2024

(54) DRILLHOLE ASPECT RATIO

(71) Applicant: Deep Isolation, Inc., Berkeley, CA (US)

(72) Inventor: Richard A. Muller, Berkeley, CA (US)

(21) Appl. No.: 18/035,575

(22) PCT Filed: Nov. 5, 2021
(86) PCT No.: PCT/US2021/058309

§ 371 Date: May 5, 2023

Related U.S. Application Data
(60) Provisional application No. 63/110,165, filed on Nov. 5, 2020.

(51) Int. Cl. G21F 9/36

(52) U.S. Cl. CPC G21F 9/36; B09B 1/008

(57) ABSTRACT

A hazardous waste repository includes a substantially vertical drillhole portion that extends toward a subterranean rock formation from a terranean surface, the drillhole including an entry at least proximate the terranean surface; and a hazardous material storage drillhole portion formed in or under the subterranean rock formation and coupled to the substantially vertical drillhole portion, the hazardous material storage drillhole portion configured to store one or more hazardous material canisters that encloses nuclear waste. The substantially vertical drillhole portion includes an aspect ratio of surface area of the substantially vertical drillhole portion to a cross-sectional area of the substantially vertical drillhole portion that impedes movement of a hazardous component of a nuclear waste material from a first end of the substantially vertical drillhole portion to a second end of the substantially vertical drillhole portion through at least one of advective isolation or diffusive isolation.

### TECHNICAL FIELD

This disclosure relates to a hazardous waste repository formed in a drillhole and, more particularly a hazardous waste repository formed in a drillhole with a particular aspect ratio.

### BACKGROUND

Hazardous waste is often placed in long-term, permanent, or semi-permanent storage so as to prevent health issues among a population living near the stored waste. Such hazardous waste storage is often challenging, for example, in terms of storage location identification and surety of containment. For instance, the safe storage of nuclear waste (e.g., spent nuclear fuel, whether from commercial power reactors, test reactors, or even high-grade military waste) is considered to be one of the outstanding challenges of energy technology. Safe storage of the long-lived radioactive waste is a major impediment to the adoption of nuclear power in the United States and around the world. Conventional waste storage methods have emphasized the use of tunnels, and is exemplified by the design of the Yucca Mountain storage facility. Other techniques include boreholes, including vertical boreholes, drilled into crystalline basement rock. Other conventional techniques include forming a tunnel with boreholes emanating from the walls of the tunnel in shallow formations to allow human access.

### SUMMARY

In a general implementation, a hazardous material storage repository includes a drillhole that extends into the Earth from a terranean surface. The drillhole includes an entry at least proximate the terranean surface, a substantially vertical drillhole portion, and a hazardous material storage drillhole portion formed in or under a subterranean rock formation. The substantially vertical drillhole portion includes an aspect ratio of surface area of the substantially vertical drillhole portion to a cross-sectional area of the substantially vertical drillhole portion that impedes movement of a hazardous component of a nuclear waste material from a first end of the substantially vertical drillhole portion to a second end of the substantially vertical drillhole portion through at least one of advective isolation or diffusive isolation.

An aspect combinable with the example implementation further includes a storage canister positioned in the hazardous material storage drillhole portion.

In another aspect combinable with any of the previous aspects, the storage canister is sized to fit from the drillhole entry and into the hazardous material storage drillhole portion of the drillhole, the storage canister including an inner cavity sized to enclose nuclear waste material.

Another aspect combinable with any of the previous aspects further includes a seal positioned in the drillhole, the seal isolating the hazardous material storage drillhole portion of the drillhole from the entry of the drillhole.

In another aspect combinable with any of the previous aspects, the nuclear waste material includes at least one of spent nuclear fuel or TRU waste.

In another aspect combinable with any of the previous aspects, the TRU waste includes RH TRU waste.

In another aspect combinable with any of the previous aspects, the substantially vertical drillhole portion is between 1000 feet and 5000 feet in length.

In another aspect combinable with any of the previous aspects, the substantially vertical drillhole portion includes a radius of at least 0.1 meters.

In another aspect combinable with any of the previous aspects, the drillhole further includes a non-vertical drillhole portion.

In another aspect combinable with any of the previous aspects, the non-vertical drillhole portion includes a tilted, curved, or horizontal drillhole portion.

In another aspect combinable with any of the previous aspects, the drillhole is uncased.

Another aspect combinable with any of the previous aspects further includes a casing installed in at least a portion of the drillhole; and a cement layer installed adjacent the casing.

In another aspect combinable with any of the previous aspects, the casing includes a plurality of casing segments, each of the casing segments including a male beveled end and a female beveled end.

In another aspect combinable with any of the previous aspects, the storage canister is one of a plurality of storage canisters, each of the plurality of storage canisters positioned within a hardenable material placed in the hazardous material storage drillhole portion.

In another aspect combinable with any of the previous aspects, the hardenable material includes cement or concrete.

In another aspect combinable with any of the previous aspects, the hardenable material is placed in the hazardous material storage drillhole portion with one or more flexible enclosures.

In another aspect combinable with any of the previous aspects, the seal is placed at the entry of the drillhole or in the substantially vertical drillhole portion.

In another example implementation, a method for storing hazardous material includes forming a drillhole that extends into the Earth from a terranean surface, the drillhole including an entry at least proximate the terranean surface, the drillhole including a substantially vertical drillhole portion and a hazardous material storage drillhole portion formed in or under a subterranean rock formation, the substantially vertical drillhole portion including an aspect ratio of surface area of the substantially vertical drillhole portion to a cross-sectional area of the substantially vertical drillhole portion that impedes movement of a hazardous component of a nuclear waste material from a first end of the substantially vertical drillhole portion to a second end of the substantially vertical drillhole portion through at least one of advective isolation or diffusive isolation, the storage canister including an inner cavity sized to enclose the nuclear waste material; and positioning a seal in the drillhole, the seal configured to isolate the hazardous material storage drillhole portion of the drillhole from the entry of the drillhole.

In an aspect combinable with the example implementation, the nuclear waste material includes at least one of spent nuclear fuel or TRU waste.

In another aspect combinable with any of the previous aspects, the TRU waste includes RH TRU waste.

In another aspect combinable with any of the previous aspects, the substantially vertical drillhole portion is between 1000 feet and 5000 feet in length.

In another aspect combinable with any of the previous aspects, the substantially vertical drillhole portion includes a radius of at least 0.1 meters.

In another aspect combinable with any of the previous aspects, the drillhole further includes a non-vertical drillhole portion.

In another aspect combinable with any of the previous aspects, the to non-vertical drillhole portion includes a tilted, curved, or horizontal drillhole portion.

In another aspect combinable with any of the previous aspects, the drillhole is uncased.

In another aspect combinable with any of the previous aspects, the drillhole includes a casing installed in at least a portion of the drillhole; and a cement layer installed adjacent the casing.

In another aspect combinable with any of the previous aspects, the casing includes a plurality of casing segments, each of the casing segments including a male beveled end and a female beveled end.

In another aspect combinable with any of the previous aspects, the storage canister is one of a plurality of storage canisters, each of the plurality of storage canisters positioned within a hardenable material placed in the hazardous material storage drillhole portion.

In another aspect combinable with any of the previous aspects, the hardenable material includes cement or concrete.

In another aspect combinable with any of the previous aspects, the hardenable material is placed in the hazardous material storage drillhole portion with one or more flexible enclosures.

In another aspect combinable with any of the previous aspects, positioning the seal in the drillhole includes positioning the seal in the drillhole at the entry of the drillhole or in the substantially vertical drillhole portion

In another example implementation, a hazardous waste repository includes a substantially vertical drillhole portion that extends toward a subterranean rock formation from a terranean surface, the drillhole including an entry at least proximate the terranean surface; and a hazardous material storage drillhole portion formed in or under the subterranean rock formation and coupled to the substantially vertical drillhole portion, the hazardous material storage drillhole portion configured to store one or more hazardous material canisters that encloses nuclear waste. The substantially vertical drillhole portion includes an aspect ratio of surface area of the substantially vertical drillhole portion to a cross-sectional area of the substantially vertical drillhole portion that impedes movement of a hazardous component of a nuclear waste material from a first end of the substantially vertical drillhole portion to a second end of the substantially vertical drillhole portion through at least one of advective isolation or diffusive isolation.

In an aspect combinable with the example implementation, the nuclear waste material includes at least one of spent nuclear fuel or TRU waste.

In another aspect combinable with any of the previous aspects, the substantially vertical drillhole portion is between 1000 feet and 5000 feet in length.

In another aspect combinable with any of the previous aspects, the substantially vertical drillhole portion includes a radius of at least 0.1 meters.

In another aspect combinable with any of the previous aspects, the drillhole further includes a non-vertical drillhole portion.

In another aspect combinable with any of the previous aspects, the non-vertical drillhole portion includes a tilted, curved, or horizontal drillhole portion.

In another aspect combinable with any of the previous aspects, the hazardous material storage drillhole portion is formed in at least part of the non-vertical drillhole portion.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic illustration of an example implementation of a hazardous waste repository formed in a drillhole according to the present disclosure.

FIG. 2 is a schematic illustration of a substantially vertical drillhole portion of a hazardous waste repository according to the present disclosure.

### DETAILED DESCRIPTION

A hazardous waste repository (sometimes referred to as a hazardous material storage repository) for the disposal of nuclear and other toxic waste includes a vertical drillhole, or directional drillhole (e.g., wellbore) that has a vertical (or substantially vertical) portion and a horizontal (or substantially horizontal) portion coupled together with a transition portion (e.g., a radiused portion or slightly inclined portion). The horizontal portion is accessed through the vertical or nearly vertical portion (e.g., an “access” drillhole). Canisters containing the waste can be lowered in the vertical access hole and then pushed into the horizontal disposal section (or emplaced at a downhole end of the vertical drillhole) using a variety of techniques, including wireline with tractor, coiled tubing, and drill pipe.

Once the canisters that enclose the waste (e.g., spent nuclear fuel (SNF) assemblies, high level waste, TRansUranic (TRU) waste or other toxic waste) is in place, and the repository is determined to meet the required specifications (e.g., from the U.S. Nuclear Regulatory Commission), the vertical access hole can be sealed. In some aspects, a subterranean formation into which (or under which) the hazardous waste is stored can be shale, salt, hard rock (e.g. granite or basalt) or other formation that, in some aspects, may exhibit some desired level of impermeability.

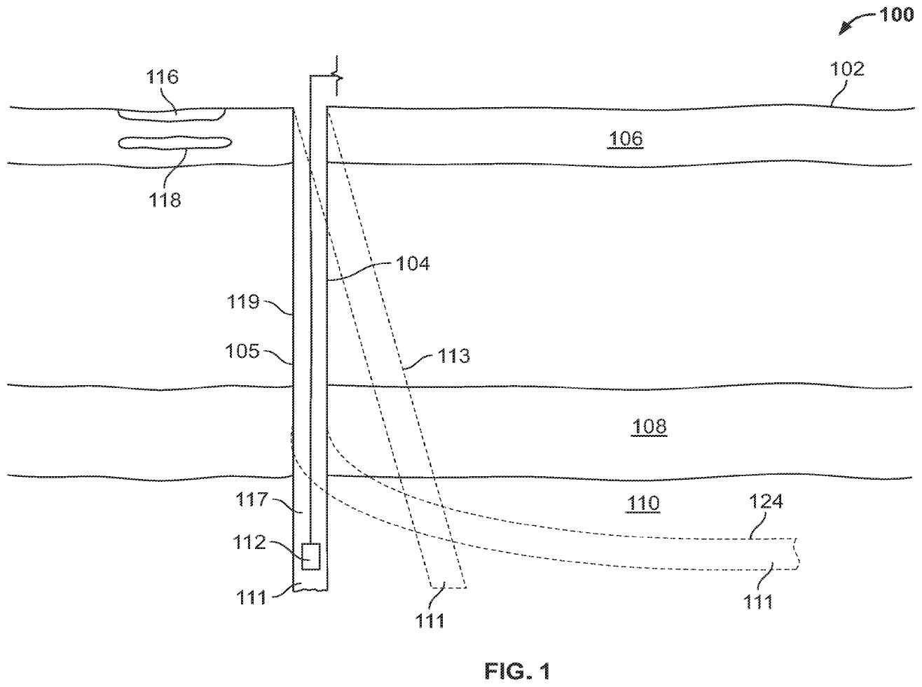

The present disclosure describes example implementation of a hazardous waste repository formed in or as part of a drillhole (or wellbore or borehole) that can be vertical or directional and that is constructed with a particular geometry to provide isolation of the emplaced waste from a terranean surface, from a source of mobile water, or both. In an example inventive embodiment of the present disclosure shown in FIG. 1, a hazardous waste repository 100 for hazardous waste (e.g., spent nuclear fuel, high level waste, TRU, or other waste) is shown that includes one or more drillholes 104 (e.g., drillholes or drillholes) formed (e.g., drilled) from the Earth's surface 102, through one or more intermediate formation 106 and 108, and into a subterranean formation 110 (e.g., shale or salt formation, or otherwise). Each of the drillholes 104 can include an access, or substantially vertical, drillhole portion 105.

In some aspects, the drillholes 104 are only vertical (or substantially vertical taking into account slight offsets due to the drilling process) and thus can only include the access, or substantially vertical, drillhole portion 105. In some aspects, the drillholes 104 include non-vertical portions 124, such as curved or horizontal (or substantially horizontal) portions that are coupled to vertical portions that extend into the Earth, through subterranean formations 106 and 108, from the surface 102, and into the salt formation 110. In some aspects, one or more formations, such as a surface formation 106, may include surface water 116 or sub-surface, mobile water 118. One or more canisters 112 containing hazardous waste is positioned in a storage portion 111 of the drillholes 104 that is located in the subterranean formation 110. In some aspects, all or a part of the drillhole 104 (such as a portion close to the surface 102) may be cased with a casing 119 (which is formed from multiple casing joints that are connected, e.g., threadingly, together). In some aspects, the casing 119 can include a cement layer to secure the casing 119 to the subterranean formations.

In some aspects, the drillholes 104 can be long drillholes, such as 1000 to 2800 feet in length, or longer. In an example configuration, the drillholes are vertical, wide enough to accommodate individual canisters 112, and deep enough to store waste within a particular subterranean formation. As shown in FIG. 1, the drillhole 104 could be vertical, tilted, or have a gradually changing direction (such as horizontal portion 124 coupled to drillhole 104 through a curved portion).

Drillhole 104 or other drillhole (vertical or directional) drilled from the terranean surface 102 into the sub-surface formation 110 for the disposal of, e.g., nuclear waste material, may be constructed with a particular geometry to provide isolation of the waste from the surface, from a source of mobile water, or both. For example, the rock in the disposal formations is typically millions of years old and has have little interaction with the surface. However, the isolative properties of the rock (e.g., to sealingly store or isolate any waste material escaped from the canister). A challenge is that the isolation is compromised when a drillhole is dug or drilled to reach the formation. Moreover, the rock near a drillhole is “disturbed” to an additional distance of about half a drillhole radius. Although a drillhole can be “backfilled” with rock, cement, bentonite, and other material, it may be difficult to know (and even harder to demonstrate) that such a man-made barrier will last for hundreds of thousands to millions of years, as typically required by regulatory agencies, for the storage and disposal of radioactive material. For example, government regulations may require a compelling analysis that shows that the drillholes must offer substantial protection from radioisotope migration for a million years. One challenge is to show that a long-lived isotope, such as iodine-129 (16 million year half-life) will not escape in such a long period of time.

The problem is made more difficult by the fact that I-129 and several other dangerous radioisotopes (e.g., Cl-36) are readily soluble in water. Rock typically has a few percent of water by volume in pores and cracks, and this water may flow into the drillhole and may fill, e.g., a storage portion of the drillhole where the canisters are emplaced. Once dissolved in water, I-129 and Cl-36 can move with the flow, driven by gravity and pressure gradients, and they can move within the water by diffusion. Present pressure gradients, and also future gradients that can arise from, e.g., changes in surface water, deep aquifer flow, the possible pumping of a carbon dioxide storage and sequestration plant ten kilometers away, or the appearance of a nearby glacier, may be taken into account.

To guarantee safety, a conservative assumption can be made that after a few thousand years (short compared to the million-year safety requirement), the canisters have corroded, and the dangerous radioisotope is dissolving (or has dissolved) in the water. It may also be assumed that the deep water pressure might increase, and that could provide a force that can drive the radioactive water up the access hole.

Of course, the drillhole may be plugged with cement (or other hardenable material 117 as shown). Disposal sites can be chosen in low permeability rock which is highly resistant to water flow. Measurements of the rock are required to show that they will provide an impermeable cap. But the drillhole itself, such as a vertical portion of the drillhole, can present a problem. It can be filled with concrete or other material, but there is no guarantee that any fill material will provide a seal that can last 100,000 or a million years. If old cement crumbles, then it might provide no better protection than sand.

Another commonly proposed fill material is bentonite, which swells when it absorbs fresh water and makes a tight seal. In some aspects, bentonite may shrink, crack, and it too may be no better than sand (or cement) at plugging the drillhole. To put this in perspective, with a 10 atmosphere overpressure at a depth of 1.5 km, water from depth would take only a few thousand years to reach the surface. Perhaps even worse, bentonite fails to swell when exposed to salt water, and deep water entrained in rock is typically highly saline.

In the worst-case scenario, it may be assumed that a high pressure gradient ∂P/∂z has appeared, perhaps due to a nearby carbon-dioxide sequestration effort, perhaps due to the arrival of a glacier nearby (according to the widely accepted Milankovitch theory, a new ice age is expected in a millennium or two), or just from added flow in a deep aquifer under the disposal formation from a nearby mountain. If the permeability is high, then the flow velocity up the drillhole (e.g., a vertical portion of the drillhole 104), q, can be small, and the radioisotopes will decay before they reach the surface. To achieve this goal, the hole is filled with material that has high permeability. But as noted, it is difficult to know if such a fill will endure. Cement, for example, may crack or crumble after thousands of year of elevated temperature and pressure applied by the surrounding rock. When cracks and fissures appear in the seal, the permeability rises rapidly, and the safety is lost. There are many skeptics, and it is not known if the strict standards of the regulatory agencies can be met. So far, no high-level nuclear waste has been disposed underground in drillholes anywhere in the world.

To address this problem, the present disclosure describes example embodiments of a hazardous waste repository (such as the repository 100) that includes a drillhole formed with a particular geometry to provide isolation of the waste from the terranean surface through a pathway up the drillhole. In particular, the geometry can limit access to the repository to a pathway that has a very high aspect ratio, such as a pathway with a much greater surface area than cross-section of the pathway itself.

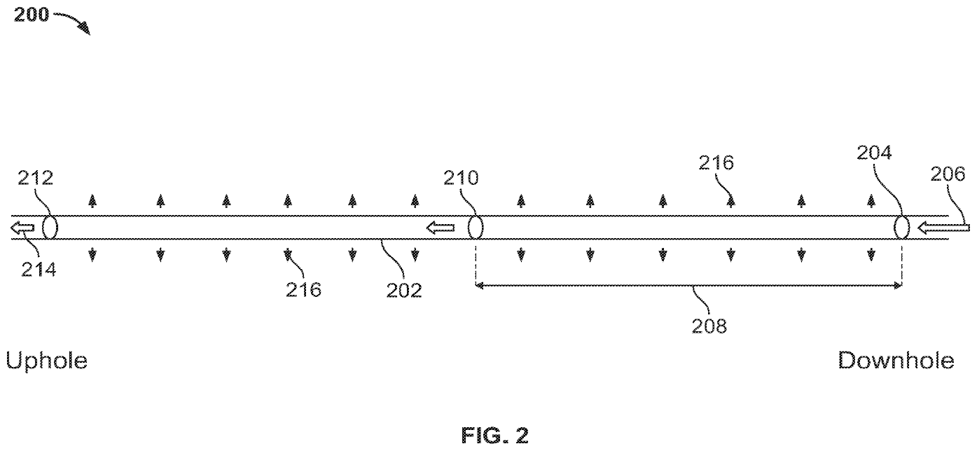

For example, consider a cylindrical pathway (that can represent a vertical portion 105 of a drillhole 104, or simply a vertical drillhole), such as is shown in FIG. 2, with radius R and length L. In some aspects, R represents a radius of a cased drillhole (i.e., the distance from centerline of the drillhole to an inner surface of the casing). In some aspects, R represents a radius of an open (uncased) drillhole (i.e., the distance from centerline of the drillhole to the formation).

The surface area of the cylinder, AS, is 2πRL, and the area of the cross-sectional circle, AC, is πR². Then the area aspect ratio, AR, is: AR=2πRL/πR²=2L/R. To keep examples simple, this discussion is limited to a vertical drillhole portion 105 (or access pathway) that has a circular cross-section. However, the present disclosure applies equally to access pathways of non-circular cross-sections as well.

Consider a mined repository with a cylindrical (horizontal) access pathway with a radius 2.5 meters (similar to that of the proposed Yucca Mountain repository) and length of 1.25 km. The aspect ratio for this access pathway is AR=2×1250/2.5=1000. In contrast, a drillhole portion 105 (such as a vertical drillhole or vertical drillhole portion) with a radius, R=0.2 m, and length (e.g., depth to a subterranean formation in which the storage portion of the drillhole is formed), L=1650 m. Then the aspect ratio is AR=2×1650/0.2=16,500. This is 16.5 times greater than for the mined repository. As explained in more detail later, there is an advantage that this geometry has for the safety of the repository.

In conventional, mined repositories (such as Yucca Mountain or WIPP), the disadvantage of the method is that for a high AR, the access pathway must be narrow (or the length L inconveniently long). This means that human and machine access through the pathway is extremely difficult or impossible. The waste must be small enough to be able to fit in a long narrow pathway. The placement of the waste most likely will be done using remotely-controlled or robotic devices. Much of the current nuclear waste is not in canisters that could be placed in the kinds of pathways that are described here. For instance, dry casks for nuclear waste is typically 8 feet in diameter, so the waste would have to be removed and placed in small canisters. That is not the case for a mined repository; in principle, a dry cask can be moved in its entirety into one of the tunnels of the proposed Yucca Mountain facility.

But one of the advantages of a repository with an access pathway having a high AR is the safety that such a repository achieves against leaks of dangerous material through the access pathway to a surface or source of mobile water underground. If the repackaging and placement issues can be addressed, then the mathematics of AR sealing imply a very effective isolation might be achieved. This, in turn, could lower the cost of obtaining regulatory approval.

In some aspects, a repository formed from a drillhole drilled from the surface (such as drillhole 104, or drillhole 113, or a vertical drillhole 105) may have a reduced liquid flow up to the surface (i.e., advective reduction) due to a particular aspect ratio in which the drillhole 105 is designed and constructed. As an example, the drillhole can be a 1500-meter long, uncased cylindrical hole in rock, with a circular cross-section with radius 0.25 meters. This example can be examined by analyzing the drillhole in segments that are 10 meters long. For each segment, the aspect ratio, AR is 2L/R=2*10/0.25=80. Thus, the area of the cylindrical surface is eight times greater than the area of the circular opening to the segment above. The circular opening may be referred to as a “mouth.”

Part of a drillhole (e.g., a substantially vertical drillhole portion) showing two segments is illustrated in FIG. 2. FIG. 2 shows, e.g., a vertical drillhole portion 200 (that extends from a downhole end at a mouth 204 to an uphole end at a mouth 212, with one or more mouths 210 therebetween). As shown, the vertical drillhole portion 200 comprises a conduit 202 through which a flow 206 enters at the mouth 204 and a flow 214 exits at mouth 212. A segment 208 can be defined between adjacent mouths of the conduit 202, such as between the mouth 204 and the mouth 210.

In some aspects, the flow out of the mouth for each segment is reduced to compared to the flow in, because of flow 216 (e.g., leakage) out the conduit 202 into the rock of the adjacent subterranean formation. In the example of FIG. 2, the drillhole 200 is considered to be vertical or near vertical.

Continuing this example, assume that a permeability of a fill (e.g., concrete or otherwise) in the drillhole 200 is eighty times greater than a permeability of the surrounding rock formation of the drillhole 200 (high permeability means greater flow for the same pressure difference). It would appear, then, that the fill offers a fast-path for radioactive fluids to the surface or to a source of mobile water (or both). But the area of the mouth 212, representing that fast path, is 1/80 the area presented by the surrounding lower-permeability rock (i.e., the area aspect ratio for these example dimensions). Because of the higher permeability, the flow per unit area through the mouth 212 will be eighty times greater than the flow per unit area through the conduit 202. But because the sides have eighty times as much area as does the mouth, the flows are equal.

Thus, for each segment 208, half of the water (i.e., radioactive fluid) flows into the formation as flow 216 and half flows through the mouth 210 (i.e., half of the flow 206 that entered mouth 204). The same effect can hold for the next segment (e.g., a segment that starts at mouth 210 and continues to another mouth), and for the next after that, and so on. In 1500 meters, there can be 150 segments (assuming a segment length of 10 meters). The final flow 214 out the final mouth 212 (i.e., the exit mouth of the segment closest to the surface) to the surface will be ½×½×. . . ×½=(½)(½)¹⁵⁰=7×10⁻⁴⁶. This reduction in the flow 214 out of the shallowest segment of the drillhole 200 (e.g., at a terranean surface entry), compared to the flow 206 that entered the deepest segment of the drillhole 200 (e.g., mouth 204 where a hazardous waste repository portion connects to the drillhole 200), is a consequence of the large aspect ratio. The effect is, as shown, exponential decrease in the hole flow vs. length of drillhole 200.

The purpose of this rough calculation was to illustrate the exponential reduction effect. In a real geology, many other factors enter. As the surrounding rock fills with water from the hole, the pressure difference changes, and that affects flow. The nature of the rock changes along the hole. And the whole process is continuous, not in segments. To take these complexities into account, a complete numerical simulation using a rock model and computer code can be performed.

In addition to advection (the dispersal of the radioactivity by water flow into the rock), there is another effect that, even if advection was not present, disperses the radioactivity into the rock: diffusion. The diffusion effect by itself can prove to be important in the case in which the surrounding rock has low permeability. Diffusion refers to the motion of individual molecules, even when the solute (e.g., brine) is not moving. If there is a gradient in concentration, e.g., there is a higher concentration of I-129 (or other isotope) in the drillhole than there is in the rock, then the random molecular motion of the molecules causes the gradient to decrease, since random motion into the low concentration zone will be larger than random motion back.

Diffusion is described by Fick's Law, which posits that the flow per unit area is proportional to the concentration gradient, inversely proportional to the viscosity (viscous molecules move slowly), and proportional to the diffusion coefficient (D) of the material. As the radioisotopes move up through the rock, they tend to diffuse into the surrounding rock, and thus the upward flow is reduced. This effect can also be exponential in nature. Even rock formations that have low permeability often have a diffusion coefficient, D, of approximately 10⁻¹⁰, and this is large enough to deplete the radioactive isotope concentration in the drillhole.

In an example, the first 1 meter of water as it moves up the fill of the drillhole 200 can be followed. Assume that the drillhole is filled with sand (k=10⁻¹³), and that the pressure gradient is 10 bar=10⁶ Pa over 1500 meters, ∂P/∂z=67 Pa/m. The velocity, v, of flow is determined by Darcy's Law, which states that v=(k/μ)(∂P/∂Z), where μ=10⁻³ is the viscosity of the water. Thus, v=6.7×10⁻⁹ m/s=0.2 m/y. This means that the 1-meter plug of water will move its own length in 5 years.

An estimation of how much diffusion there is into the rock can also be performed. Diffusion is described by Darcy's Law, and a simple solution for one dimensional flow yields the well-known result x=2√(Dt). A reasonable diffusion constant for rock is D=10⁻¹⁰. Taking t=5 years=16×10⁷ sec, gives x=0.24 m=24 cm. This distance is roughly the radius of the drillhole, so the material is now spread over an area four times as large as when it entered the drillhole. Put another way, 25% of the fluid remains in the drillhole; the rest has diffused into the rock formation. A similar loss takes place over the next meter, and so on. At the end of the 1500 meters, the amount remaining in the hole is reduced by a factor of 0.251500=10⁻⁹⁰⁰. This is so small that not a single atom of I-129 in the first pulse would reach the surface.

The situation can be different for the last meter of water moving up the drillhole 200 since, as the radioactivity moves into the rock, back diffusion can become important. In some aspects, direct calculation is difficult, so a numerical simulation can be performed. In some aspects, results of the numerical simulation show that most of the radioactivity remains deeply buried near the initial part of the drillhole. For example, for a complete pressurized water reactor (PWR) load of radioactive waste, the largest components that reach the surface through the drillholes comes from the long-lived I-129. The computation shows that some radioactivity does reach a surface aquifer, but the level is low, such that if 100% of the water that a person drinks is from that aquifer, then the yearly dose received would be less than a microrem. That is a factor of 10,000 lower than the regulatory requirement, and a factor of a million less than the typical dose that a human receives every year from natural cosmic radiation.

In sum, for the net effect of advective and diffusive isolation due to a particular aspect ratio of a drillhole, any escaped radioisotope, according to the numerical simulation, is shown to be minimal. Thus, by constructing a drillhole (e.g., a substantially vertical drillhole or substantially vertical drillhole portion of a directional drillhole) with a particular aspect ratio, escaped isotopes from enclosed nuclear waste can be impeded from being entrained in a flow of fluid through the drillhole or the flow of fluid (e.g., liquid or gas), or both. As described, the AR can be a dimensionless number that is between, for example, 333 and 128,000 depending on the radius of the drillhole and the length of the substantially vertical drillhole portion. For example, the radius can be between 1.5 inches and 18 inches, and the length can be between 1,000 ft. and 16,000 feet deep.

As described, the numerical simulation shows that for a sand filled drillhole drilled in a sedimentary rock formation, the radioactive dose at a drinking well after a million years is only 5% of the dose came from the access hole. Since the dose is a factor of 1000 below the acceptable health risk dose, this puts it a factor of below the health limit of 10 mrem/year and through subterranean formations 108 and 110 that are deeper than the surface water formation 106. Each of the formations 106, 108, and 110 may comprise a geologic formation formed of one or more rock types, as well as water (e.g., fresh or brine) and in some cases other fluids (e.g., hydrocarbon fluids). In this example, the test drillhole 104 is shown as a vertical drillhole. However, in alternative implementations, a directional drillhole 124 (shown in dashed line) may be formed and used in the repository 100 in place of (or in addition to) the test drillhole 104) according to the present disclosure.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

1. A hazardous material storage repository, comprising:
a drillhole that extends into the Earth from a terranean surface, the drillhole comprising an entry at least proximate the terranean surface, the drillhole comprising a substantially vertical drillhole portion and a hazardous material storage drillhole portion formed in or under a subterranean rock formation, the substantially vertical drillhole portion comprising an aspect ratio of surface area of the substantially vertical drillhole portion to a cross-sectional area of the substantially vertical drillhole portion that impedes movement of a hazardous component of a nuclear waste material from a first end of the substantially vertical drillhole portion to a second end of the substantially vertical drillhole portion through at least one of advective isolation or diffusive isolation;
a storage canister positioned in the hazardous material storage drillhole portion, the storage canister sized to fit from the drillhole entry and into the hazardous material storage drillhole portion of the drillhole, the storage canister comprising an inner cavity sized to enclose the nuclear waste material; and
a seal positioned in the drillhole, the seal isolating the hazardous material storage drillhole portion of the drillhole from the entry of the drillhole.

2. The hazardous material storage repository of claim 1, wherein the nuclear waste material comprises at least one of spent nuclear fuel or TRU waste.

3. (canceled)

4. The hazardous material storage repository of claim 1, wherein the substantially vertical drillhole portion is between 1000 feet and 5000 feet in length.

5. The hazardous material storage repository of claim 4, wherein the substantially vertical drillhole portion comprises a radius of at least 0.1 meters.

6. The hazardous material storage repository of claim 1, wherein the drillhole further comprises a non-vertical drillhole portion that comprises a tilted, curved, or horizontal drillhole portion.

7. (canceled)

8. (canceled)

9. The hazardous material storage repository of claim 1, further comprising:
a casing installed in at least a portion of the drillhole; and
a cement layer installed adjacent the casing.

10. The hazardous material storage repository of claim 9, wherein the casing comprises a plurality of casing segments, each of the casing segments comprising a male beveled end and a female beveled end.

11. The hazardous material storage repository of claim 1, wherein the storage canister is one of a plurality of storage canisters, each of the plurality of storage canisters positioned within a hardenable material placed in the hazardous material storage drillhole portion.

12. (canceled)

13. The hazardous material storage repository of claim 11, wherein the hardenable material is placed in the hazardous material storage drillhole portion with one or more flexible enclosures.

14. (canceled)

15. A method for storing hazardous material, comprising:
forming a drillhole that extends into the Earth from a terranean surface, the drillhole comprising an entry at least proximate the terranean surface, the drillhole comprising a substantially vertical drillhole portion and a hazardous material storage drillhole portion formed in or under a subterranean rock formation, the substantially vertical drillhole portion comprising an aspect ratio of surface area of the substantially vertical drillhole portion to a cross-sectional area of the substantially vertical drillhole portion that impedes movement of a hazardous component of a nuclear waste material from a first end of the substantially vertical drillhole portion to a second end of the substantially vertical drillhole portion through at least one of advective isolation or diffusive isolation;
moving a storage canister through the drillhole from the entry into the hazardous material storage drillhole portion, the storage canister sized to fit from the drillhole entry and into the hazardous material storage drillhole portion of the drillhole, the storage canister comprising an inner cavity sized to enclose the nuclear waste material; and
positioning a seal in the drillhole, the seal configured to isolate the hazardous material storage drillhole portion of the drillhole from the entry of the drillhole.

16. The method of claim 15, wherein the nuclear waste material comprises at least one of spent nuclear fuel or TRU waste.

17. (canceled)

18. The method of claim 15, wherein the substantially vertical drillhole portion is between 1000 feet and 5000 feet in length.

19. The method of claim 18, wherein the substantially vertical drillhole portion comprises a radius of at least 0.1 meters.

20. The method of claim 15, wherein the drillhole further comprises a non-vertical drillhole portion that comprises a tilted, curved, or horizontal drillhole portion.

21. (canceled)

22. (canceled)

23. The method of claim 15, wherein the drillhole comprises:
a casing installed in at least a portion of the drillhole; and
a cement layer installed adjacent the casing.

24. The method of claim 23, wherein the casing comprises a plurality of casing segments, each of the casing segments comprising a male beveled end and a female beveled end.

25. The method of claim 15, wherein the storage canister is one of a plurality of storage canisters, each of the plurality of storage canisters positioned within a hardenable material placed in the hazardous material storage drillhole portion.

26. (canceled)

27. (canceled)

28. (canceled)

29. A hazardous waste repository, comprising:
a substantially vertical drillhole portion that extends toward a subterranean rock formation from a terranean surface, the drillhole comprising an entry at least proximate the terranean surface; and
a hazardous material storage drillhole portion formed in or under the subterranean rock formation and coupled to the substantially vertical drillhole portion, the hazardous material storage drillhole portion configured to store one or more hazardous material canisters that encloses nuclear waste,
wherein the substantially vertical drillhole portion comprises an aspect ratio of surface area of the substantially vertical drillhole portion to a cross-sectional area of the substantially vertical drillhole portion that impedes movement of a hazardous component of the nuclear waste from a first end of the substantially vertical drillhole portion to a second end of the substantially vertical drillhole portion through at least one of advective isolation or diffusive isolation.

30. (canceled)

31. The hazardous waste repository of claim 29, wherein the substantially vertical drillhole portion is between 1000 feet and 5000 feet in length, and the substantially vertical drillhole portion comprises a radius of at least 0.1 meters.

32. (canceled)

33. The hazardous waste repository of claim 29, wherein the drillhole further comprises a non-vertical drillhole portion.

34. (canceled)

35. (canceled)
